(19) United States
(12) Patent Application Publication
(10) Pub. No.: US 2018/0271731 A1
(43) Pub. Date: Sep. 27, 2018

(54) BED LIFTING FRAME

(71) Applicants: JIAXING SINO HARDWARE MANUFACTURING COMPANY LIMITED, Jiaxing (CN); SINO INTERNATIONAL GROUP LIMITED, Monkok KL (HK)

(72) Inventor: Klaus Bellingroth, Gummersbach (DE)

(21) Appl. No.: 15/464,412

(22) Filed: Mar. 21, 2017

(51) Int. Cl. A61G 7/16; A61G 7/015; A61G 7/018; A61G 7/07; A61G 7/075

(52) U.S. Cl. CPC A61G 7/16; A61G 7/015; A61G 7/0755; A61G 7/07; A61G 7/018

(57) ABSTRACT

A bed lifting frame for motorized height adjustment of a lying surface includes a head unit, a foot unit, and two frame elements. The head unit includes a first support unit and a head part which is mounted in a height-adjustable manner on the first support unit. The foot unit includes a second support unit and a foot part which is mounted in a height-adjustable manner on the second support unit. The two frame elements connect the head unit and the foot unit and are spaced apart from each other. The foot unit (3) includes two separate lifting columns (9), which are arranged and spaced apart from each other in such a way that a free passage area (10) is formed between the lifting columns (9).

### FIELD

The present invention relates to a bed lifting frame for motorized height adjustment of a lying surface, the bed lifting frame having a head unit with a first support unit and a head part which is mounted in a height-adjustable manner on the first support unit, a foot unit with a second support unit and a foot part which is mounted in a height-adjustable manner on the second support unit, and two frame elements which connect the head unit and the foot unit and are spaced apart from each other.

### BACKGROUND

Bed lifting frames of the type mentioned in the opening paragraph are known in various embodiments from the prior art. They enable a comfortable adjustment of the lying surface of a bed which is formed with the bed lifting frame and used preferably in the medical field as well as the nursing field. The height adjustment enables patients with limited mobility as well as the nursing staff to access easily to the lying surface.

However, despite their height adjustment, known bed lifting frames have the disadvantage that one is forced to turn in the bed by 90° both before leaving the bed and before lying down.

Thus, in the process of standing up, it is necessary to first bring the back into an upright position and then turn 90°, whereby the legs are guided over the edge of the bed. When entering the bed, one must also turn 90° after sitting down on the lying surface in order to be able to lay down the legs and the back on the lying surface subsequently. In particular, the turning movement is very difficult for the person severely impaired in the movement ability and is often possible only with the support of the nursing staff.

### SUMMARY

The object of the invention is to provide a bed lifting frame which allows easy access to and exit from a bed which is formed with the bed lifting frame.

The invention solves the problem by means of a bed lifting frame with the features of claim 1.

Advantageous further developments of the invention are specified in the dependent claims.

The bed lifting frame according to the invention is wherein the foot unit has two separate lifting columns which are designed and spaced apart from each other in such a way that a free passage area is formed between the lifting columns. In contrast to the bed lifting devices known from the prior art, the foot unit according to the invention has two separate lifting columns. The arrangement of the lifting columns is in this case at a distance from one another, whereby a direct connecting element, which bridges the immediate distance between the lifting columns, is dispensed with, so that a free passage area exists between the lifting columns, which allows for an unimpeded passage between the lifting columns.

The embodiment according to the invention of the bed lifting frame with a free passage area between the lifting columns thus allows for a comfortable access to the lying surface, wherein one can leave and enter the lying surface without any previous turning movement on the lying surface. In particular, for persons restricted in their movement, the access to the bed according to the invention is facilitated in a particular way compared with known beds. The embodiment according to the invention of the bed lifting frame allows access via the foot end of the bed.

Furthermore, the possibility of adjusting the head unit and foot unit makes it possible to optimally adjust the height of the lying surface of the bed lifting frame according to the invention, whereby the lying surface can also be inclined relative to a horizontal by means of the possibility of separate displacement of the head part and foot part relative to their respective support units.

According to a particularly advantageous embodiment of the invention, it is further provided that the lifting columns each have a second support unit configured as a foot support and a foot part configured as a column body, and the column bodies are mounted on the foot supports via separate drive units in a height-adjustable manner. According to this embodiment of the invention, the lifting columns each comprise a foot support, wherein the foot supports together form the second support unit. The respective column units arranged on the support units are in this case adjustable separately from one another by means of suitable drive units.

A separate height adjustment of the column bodies of the two lifting columns increases the possibilities for adjustment of the lying surface of the bed lifting frame to an additional extent. For example, unevenness of the floor can be compensated by a height adjustment of the column bodies which are separated from one another, or specific inclinations of the lying surface can be achieved. In the case of a uniform adjustment of the height position of the column bodies, there is basically also the possibility of a synchronization of the drive units, so that the lying surface in the area of the lifting columns has a uniform height spacing from the ground.

The separate arrangement of the lifting columns allows for particularly good access to the lying surface due to the free passage area. In addition, the lifting columns can also be used as an entry and exit aid for the bed, whereby the person using the bed can support himself or herself on the lifting columns. According to a further embodiment of the invention, it is further provided that retaining handles are arranged on the column bodies. The use of retaining handles improves the possibility of support on the lifting columns. Particularly advantageously, the retaining handles are arranged on the upper sides of the lifting columns in such a way that they are arranged above the upper sides and do not project beyond the side walls of the lifting column. A corresponding arrangement of the retaining handles enables a good utilization of the lifting columns as entry and exit aid. In addition, by means of an arrangement of the retaining elements arranged above the upper sides of the column bodies, it is ensured that the passage area is not narrowed by the retaining handles.

The arrangement of the lying surface on the bed lifting frame can basically be effected in any manner, for example, the lying surface is only connected to the head part and foot part of the head unit and the foot unit. According to a particularly advantageous embodiment of the invention, however, it is provided that the lying surface is connected to the frame elements which connect the head part and foot part at a distance from one another, such that a height adjustment of the frame elements effects a corresponding height adjustment of the lying surface.

In a corresponding embodiment of the lying surface, this lying surface is essentially connected to the frame elements which in turn are connected to the head part and the foot part of the head unit and the support unit, so that a height adjustment of the head unit and the support unit also causes a height adjustment of the frame elements and thus a height adjustment of the lying surface. An arrangement of the lying surface essentially on the frame elements promotes a good adjustability of the lying surface as well as a free access between the lifting columns, which can be implemented in a particularly space-saving manner due to a connection of the lying surface with the frame elements.

The configurations of the lying surface can basically be selected freely. In its simplest embodiment, the lying surface is a continuous plane on which a suitable mattress can be arranged. According to a particularly advantageous embodiment of the invention, however, it is provided that the lying surface has a head/back segment and a leg segment, preferably a head/back segment, a lower leg segment and an upper leg segment, wherein the segments are pivotable relative to one another as well as with respect to the frame elements.

According to this embodiment of the invention, as a result of the possibilities for adjustment of the individual segments, the lying surface already offers the possibility to adapt the lying surface to the needs of the user. Moreover, in particular, the possibility of adjusting the head/back segment allows the user to sit upright on the lying surface in such a way that the user then can enter and leave the bed in a comfortable manner from the upright position by passing through the area between the two lifting columns without a further turning of the body, whereby an adjustment of the leg segment in the direction of the ground further facilitates the entry and exit.

The comfort during entering and leaving the bed can be further enhanced by the leg segment having an upper leg segment and a lower leg segment, wherein the lower leg segment can be pivoted relative to the upper segment such that the lying surface can take the form of a chair, wherein the lower leg segment then, for example, points essentially perpendicularly in the direction of the ground, whereby the getting into and out of the bed can be carried out in a particularly simple and comfortable manner. The possibility of adjusting the height of the lying surface ensures in particular that under the lying surface a sufficiently large area remains, which makes it possible to pivot the leg segment or lower leg segment and upper leg segment into the optimum position for entering as well as leaving the bed. In particular, the three-part configuration of the lying surface with three segments offers a particularly good adaptation of the lying surface to an optimum sitting position for entering and leaving the bed.

According to a further embodiment of the invention, it is provided that the lower leg segment can be pivoted by more than 90°, preferably more than 110°, particularly preferably more than 120°, with respect to the upper leg segment. This embodiment of the invention achieves that the lower leg segment can be pivoted so far below the upper leg segment that the feet or heels of a user can be arranged below the upper leg segment when standing up. A corresponding positioning of the feet provides a secure stand when standing up and thus additionally facilitates the leaving of the bed.

The adjustment of the individual segments to each other can in principle take place in any manner. According to a particularly advantageous embodiment of the invention, however, it is provided that the segments each have a motorized drive unit. The use of a motorized drive unit is distinguished by its comfortable operation of the lying surface and also makes it possible to secure the adjusted position in a comfortable manner via self-locking of the motor drives.

According to a further embodiment of the invention, it is further provided that the foot part and the head part are connected to one another by means of at least one longitudinal bar, wherein the longitudinal bar is mounted on the foot part and the head part in a height-adjustable manner.

The use of corresponding longitudinal bars serves as a fall protection device and thus prevents a person to be nursed from falling out of the bed. The adjustability of the longitudinal bars allows them to be adjusted to the position corresponding to the respective situation. For example, for a good access to the patients by nurses, the cross strut can be displaced into a lowered position on the head part and foot part.

### BRIEF DESCRIPTION OF THE DRAWINGS

An embodiment of the invention is explained below with reference to the drawings. In the drawings,

FIG. 1 shows a perspective view of an embodiment of a bed lifting frame with a lying surface in a lowered position;

FIG. 2a shows a first perspective view of the bed lifting frame of FIG. 1 in a raised position and a lying surface located in a sitting position;

FIG. 2b shows a second perspective view of the bed lifting frame of FIG. 1 in the position shown in FIG. 2a; and

FIG. 2c shows a side view of the bed lifting frame of FIG. 1 in the position shown in FIG. 2a.

### DESCRIPTION OF THE EMBODIMENTS

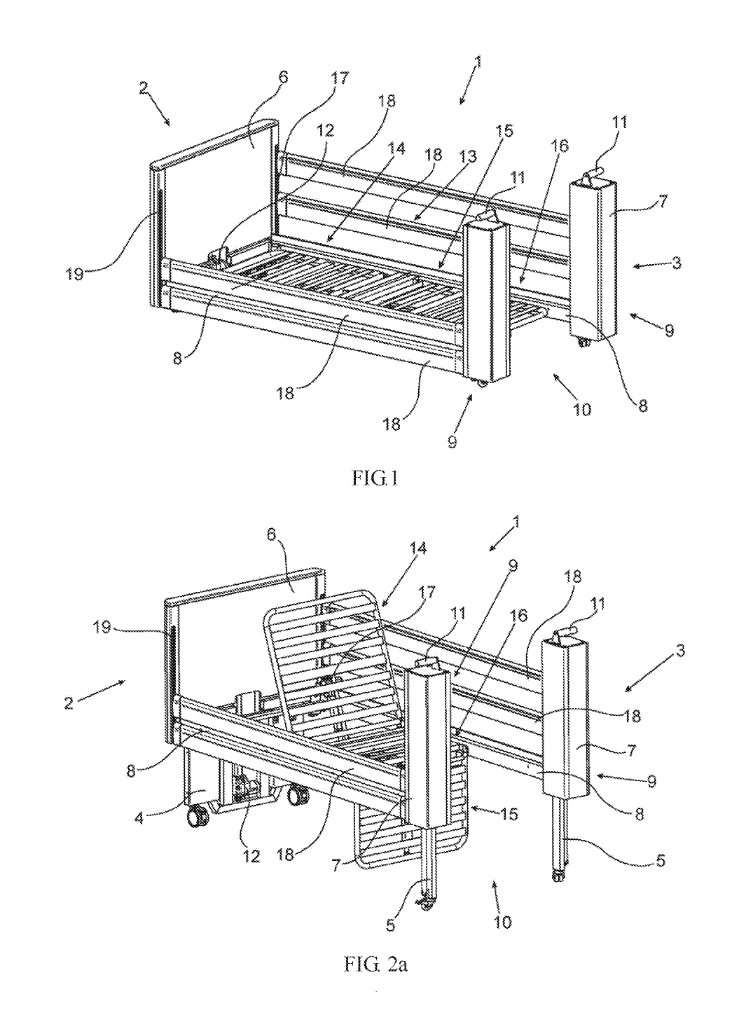

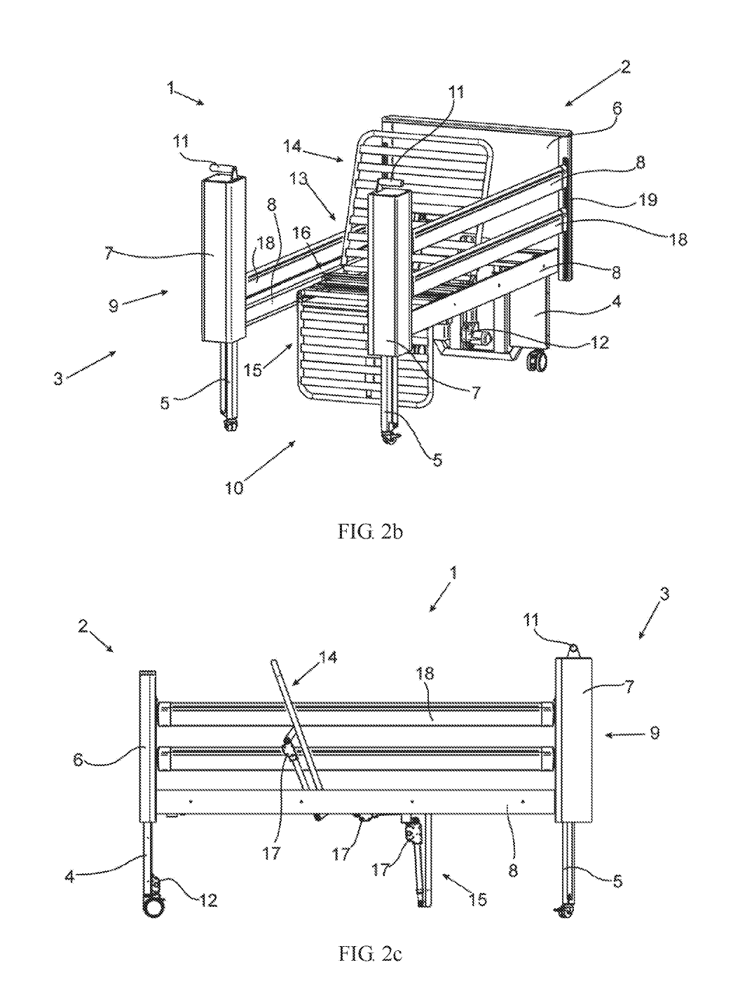

An embodiment of a bed lifting frame according to the invention is shown in FIGS. 1 and 2a-2c. The bed lifting frame 1 includes a head unit 2 and a foot unit 3 which is arranged opposite the head unit 2, wherein the head unit 2 and the foot unit 3 form the head end and foot end of the bed lifting frame 1, respectively.

The head unit 2 comprises a head part 6, which is arranged in a height-adjustable manner on a first support unit 4 which stands on a floor. In order to adjust the height of the head part 6 relative to the first support unit 4, a drive unit 12 is arranged on the first support unit 4. The drive unit 12 allows for a motorized adjustment of the head part 6 relative to the first support unit 4, wherein a self-locking of the drive unit 12 ensures the adjusted height position.

The foot unit 3 is arranged opposite the head unit 2 and forms the foot end of the bed lifting frame 1. The foot unit 3 has two lifting columns 9 which are not directly connected to one another, so that between the lifting columns 9 there is a passage area 10 which allows free access to a lying surface 13. The lifting columns 9 each have a foot support 5, wherein the foot supports 5 together form a second support unit.

A column body 7 is arranged on each of the foot supports 5 and is adjustable in height relative to the foot supports 5, wherein drive units (not shown) are used here. Although the lifting columns can be adjusted in their height separately from one another by means of the separate drive units, a synchronous adjustment of the column bodies 7 relative to the foot supports 5 of the two lifting columns 9 can also be realized by means of a suitable coupling of the drive units.

The lifting columns 9 are connected to the head part 6 via two frame elements 8 which are arranged parallel and spaced apart from one another, and the two frame elements 8 form the longitudinal sides of the bed lifting frame. A lying surface 13, which has a total of three segments, namely a head/back segment 14, an upper leg segment 16, as well as a lower leg segment 15, is arranged on the frame elements. The three segments 14, 15, 16 can be pivoted relative to one another seperately via drive units 17 so that the lying surface 13 can be adjusted from the flat position shown in FIG. 1 to the sitting position shown in FIGS. 2a-2c in which the head/back segment is lifted up and the lower leg segment 15 is lowered relative to the essentially horizontally extending upper leg segment 16, so that the lying surface 13 overall assumes a chair-like shape. The height adjustment of the head unit 2 and foot unit 3 ensures that a sufficiently large area is provided below the lying surface 13 in order to adjust the lower leg segment 15 to the lowered position in FIGS. 2a-2c.

Longitudinal bars 18 are additionally arranged above the frame elements 8. In this case, the longitudinal bars 18 are mounted in a height-adjustable manner on the column body 7 as well as the head part 6, wherein the head part 6 has a correspondingly formed groove 19 for this purpose. For comfortable entering and standing up out of the bed lifting frame 1, retaining handles 11 are arranged on the upper sides of the column bodies 7, which in particular enables a user to comfortably stand up by holding the retaining handles 11.

### Reference Number List

1 Bed lifting frame

2 Head unit

3 Foot unit

4 First support unit

5 Second support unit/foot support

6 Head part

7 Foot part/column body

8 Frame element

9 Lifting column

10 Passage area

11 Retaining handles

12 Drive unit (height adjustment)

13 Lying surface

14 Head/back segment

15 Lower leg segment

16 Upper leg segment

17 Drive unit (lying surface)

18 Longitudinal bars

19 Groove

What is claimed is:

1. A bed lifting frame for motorized height adjustment of a lying surface, comprising:
a head unit including a first support unit and a head part which is mounted in a height-adjustable manner on the first support unit;
a foot unit including a second support unit and a foot part which is mounted in a height-adjustable manner on the second support unit; and
two frame elements which connect the head unit and the foot unit and are spaced apart from each other;
wherein the foot unit (3) includes two separate lifting columns (9), which are arranged and spaced apart from each other in such a way that a free passage area (10) is formed between the lifting columns (9).

2. The bed lifting frame according to claim 1, wherein the lifting columns (9) each have a second support unit configured as a foot support (5) and a foot part configured as a column body (7), and the column bodies are mounted on the foot supports (5) via separate drive units (12) in a height-adjustable manner.

3. The bed lifting frame according to claim 1, wherein retaining handles (11) are arranged on the column bodies (7).

4. The bed lifting frame according to claim 2, wherein retaining handles (11) are arranged on the column bodies (7).

5. The bed lifting frame according to claim 1, wherein the lying surface (13) is connected to the frame elements (8) in such a way that a height adjustment of the frame elements (8) effects a corresponding height adjustment of the lying surface (13).

6. The bed lifting frame according to claim 1, wherein the lying surface (13) comprises a head/back segment (14) and a leg segment (15), wherein the segments (14, 15) are pivotable relative to one another as well as with respect to the frame elements (8).

7. The bed lifting frame according to claim 1, wherein the lying surface (13) comprises a head/back segment (14), a lower leg segment (15) and an upper leg segment (16), wherein the segments (14, 15, 16) are pivotable relative to one another as well as with respect to the frame elements (8).

8. The bed lifting frame according to claim 7, wherein the segments (14, 15, 16) each have a motorized drive unit (17).

9. The bed lifting frame according to claim 1, wherein the foot part (7) and the head part (6) are connected to one another via at least one longitudinal bar (18), wherein the longitudinal bar (18) is mounted on the foot part (7) and the head part (6) in a height-adjustable manner.

10. The bed lifting frame according to claim 7, wherein the lower leg segment (15) can be pivoted by more than 90° with respect to the upper leg segment (16).

11. The bed lifting frame according to claim 7, wherein the lower leg segment (15) can be pivoted by more than 110° with respect to the upper leg segment (16).

12. The bed lifting frame according to claim 7, wherein the lower leg segment (15) can be pivoted by more than 120° with respect to the upper leg segment (16).
